(19) United States
(12) Patent Application Publication
(10) Pub. No.: US 2007/0046760 A1
(43) Pub. Date: Mar. 1, 2007

(54) Firearm targets and methods for manufacturing firearm targets

(75) Inventor: Robert J. Zara, Rocheport, MO (US)

Correspondence Address: PERKINS COIE LLP;PATENT-SEA, P.O. BOX 1247, SEATTLE, WA, 98111-1247, US

(73) Assignee: Battenfeld Technologies, Inc., Columbia, MO (US)

(21) Appl. No.: 11/339,863

(22) Filed: Jan. 26, 2006

(51) Int. Cl. B41J 2/01

(52) U.S. Cl. 347/105

(57) ABSTRACT

Firearm targets and methods for manufacturing firearm targets are disclosed herein. In one embodiment, a target includes a substrate, a release layer on the substrate, and an ink layer on the release layer such that the release layer is positioned between the ink layer and the substrate. The ink layer at least partially defines a target image. The ink layer has a first section with a first color and a second section with a second color different than the first color.

### TECHNICAL FIELD

The present invention is related to firearm targets and methods for manufacturing firearm targets.

### BACKGROUND

Military personnel, law enforcement officers, hunters, and sport shooters use firearm targets to hone their marksmanship. Target shooting enables shooters to improve their accuracy and precision at a shooting range or other controlled environment. Conventional targets include a paper substrate and a target image printed directly onto the paper substrate. The target image often includes a bull's eye with concentric rings. One drawback of conventional targets is that it is difficult for shooters to see the bullet holes from a distance. This problem is particularly acute in darker environments and with smaller caliber rounds. As a result, shooters typically walk to the target and inspect the target at close range after firing several rounds. This process is time-consuming and may disrupt a shooter's concentration and rhythm.

One existing approach to improve the visibility of bullet holes in targets includes forming the bull's eye of the target with a layer of detachable dark ink. When a bullet strikes the bull's eye, the dark ink layer fractures around the point of impact and the fractured portion of the layer detaches from the target. Because the detached portion of the dark ink layer is larger than the bullet hole, an adjacent surface of the paper substrate is exposed. The contrast between the surrounding dark ink and the exposed paper substrate enables a shooter to identify the point of impact. One problem with this approach, however, is that not all shots strike the bull's eye, and shots that miss the bull's eye are difficult to see.

Another existing approach to improve the visibility of bullet holes in targets includes covering the entire target with the layer of detachable dark ink. Although this approach improves the visibility of all shots that strike the target, these targets are disfavored by many shooters who prefer targets with a traditional bull's eye configuration. Accordingly, there is a need to improve the visibility of bullet holes in firearm targets.

### BRIEF DESCRIPTION OF THE DRAWINGS

FIG. 1A is a schematic front view of a target assembly in accordance with one embodiment of the invention.

FIG. 1B is a schematic side view of the target assembly of FIG. 1A.

FIG. 2 is a schematic front view of the target illustrated in FIG. 1.

FIG. 3 is a schematic side cross-sectional view of the target taken substantially along line 3-3 of FIG. 2.

FIG. 4 is a schematic side cross-sectional view of a target in accordance with another embodiment of the invention.

FIG. 5 is a schematic side cross-sectional view of a target in accordance with another embodiment of the invention.

FIG. 6 is a schematic side cross-sectional view of a target in accordance with another embodiment of the invention.

FIG. 7 is a schematic front view of a target in accordance with another embodiment of the invention.

FIG. 8 is a schematic front view of a target in accordance with another embodiment of the invention.

### DETAILED DESCRIPTION

A. Overview

The following disclosure describes several embodiments of firearm targets and methods for manufacturing firearm targets. In one embodiment, a target includes a substrate, a release layer on the substrate, and an ink layer on the release layer such that the release layer is positioned between the ink layer and the substrate. The ink layer at least partially defines a target image, and has a first section with a first color and a second section with a second color different than the first color. For example, the first section can be black and the second section can be orange, red, brown, or another suitable color. The target may further include a synthetic layer between the ink layer and the substrate.

In another embodiment, a target includes a substrate, a first ink layer covering at least part of the substrate, and a second ink layer carried by the substrate. The second ink layer includes (a) a first section having a first color and covering at least part of the first ink layer, and (b) a second section having a second color different than the first color. The second ink layer is configured so that the impact of a firearm projectile (e.g., a bullet) detaches a portion of the second ink layer from the substrate and exposes a surface of the substrate and/or the first ink layer. The first ink layer may also include a first section having a third color different than the first and second colors, and a second section having a fourth color different than the first, second, and third colors.

In another embodiment, a target includes a substrate and an ink layer carried by the substrate. The ink layer includes a first section having a first color and a second section having a second color different than the first color. The target is configured such that penetration of a projectile removes a portion of the ink layer and exposes a surface adjacent to the ink layer. The target may further include a release layer positioned between the ink layer and the substrate, or a release agent in the ink layer.

Another aspect of the invention is directed to methods for manufacturing firearm targets. In one embodiment, a method includes forming a release layer on a substrate and printing an ink layer on the release layer with the ink layer at least partially defining a target image. The ink layer includes a first section with a first color and a second section with a second color different than the first color. The method may further include (a) depositing a second ink layer between the release layer and the substrate, and/or (b) disposing an adhesive layer on the substrate opposite the release layer.

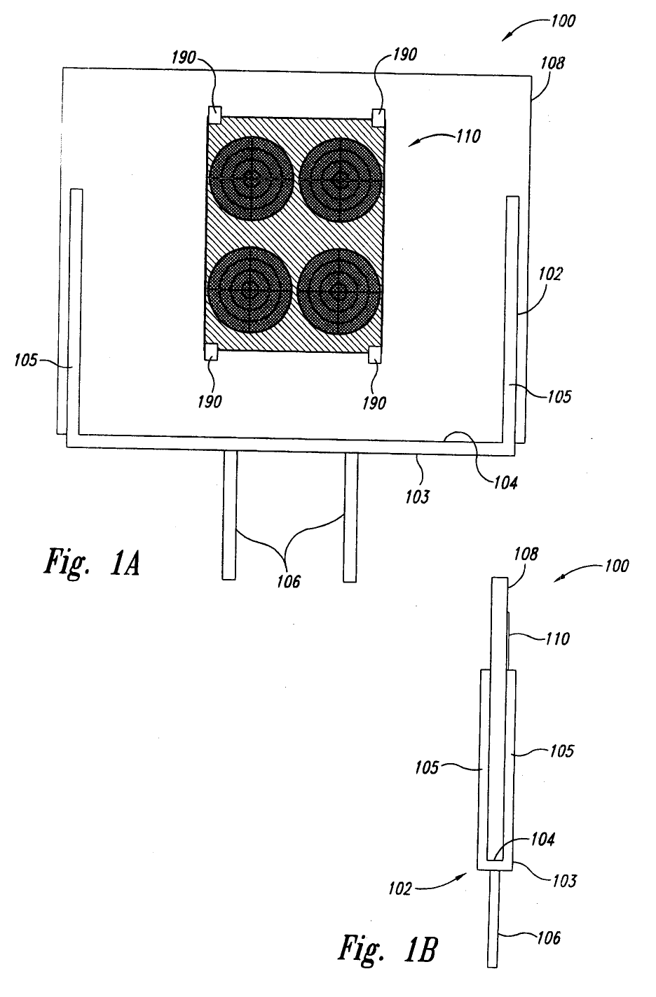

Specific details of several embodiments of the invention are described below with reference to firearm targets that are attached to a backing member with an external adhesive or fasteners, but in other embodiments the targets can have an integral adhesive layer on the back side to attach the targets to backing members Several details describing well-known structures or processes often associated with fabricating firearm targets are not set forth in the following description for purposes of brevity and clarity. Also, several other embodiments of the invention can have different configurations, components, or procedures than those described in this section. A person of ordinary skill in the art, therefore, will accordingly understand that the invention may have other embodiments with additional elements, or the invention may have other embodiments without several of the elements shown and described below with reference to FIGS. 1A-8. Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or other types of features and components are not precluded.

B. Embodiments of Target Assemblies

FIG. 1A is a schematic front view and FIG. 1B is a schematic side view of a target assembly 100 in accordance with one embodiment of the invention. The target assembly 100 includes a target stand 102, a backing member 108 carried by the target stand 102, and a target 110 attached to the backing member 108. The illustrated target stand 102 includes a base 103, a plurality of arms 105 projecting generally upward from the base 103, and a plurality of legs 106 projecting generally downward from the base 103. The base 103 includes a surface 104 for supporting the backing member 108, and the arms 105 are arranged in pairs at opposite ends of the base 103. As shown in FIG. 1B, the arms 105 in each pair are spaced apart by a gap corresponding to the thickness of the backing member 108. The legs 106 are configured for insertion into the ground so that the target assembly 100 can be used in a field or other suitable location. In other embodiments, the target stand 102 can have a different configuration, or the target assembly 100 may not include a target stand.

The backing member 108 can be placed on the target stand 102 by sliding the backing member 108 between the arms 105. The backing member 108 can be a corrugated plastic structure, a piece of paper stock, or other suitable member to which one or more targets 110 can be attached. Although the illustrated target 110 is attached to the backing member 108 with strips of tape 190, in other embodiments the target 110 can be attached to the backing member 108 with glue, staples, nails, pins, or other suitable fastening devices. Alternatively, the back side of the target 110 can include an integral adhesive layer for attaching the target 110 to the backing member 108. In other embodiments, the target assembly 100 may not include a backing member, or the backing member 108 can have a different configuration.

C. Embodiments of Targets

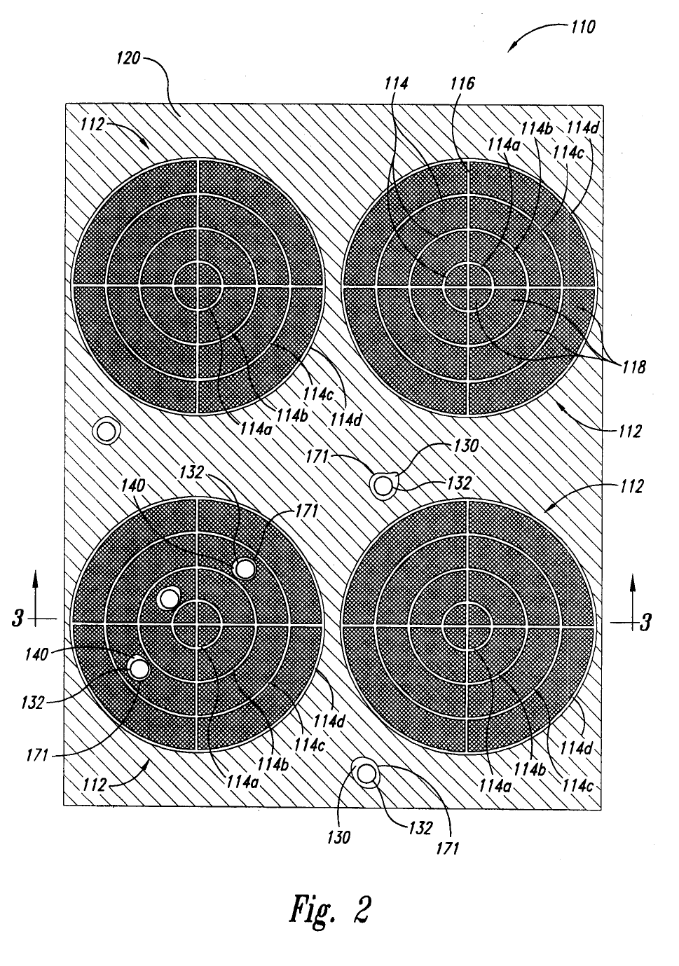

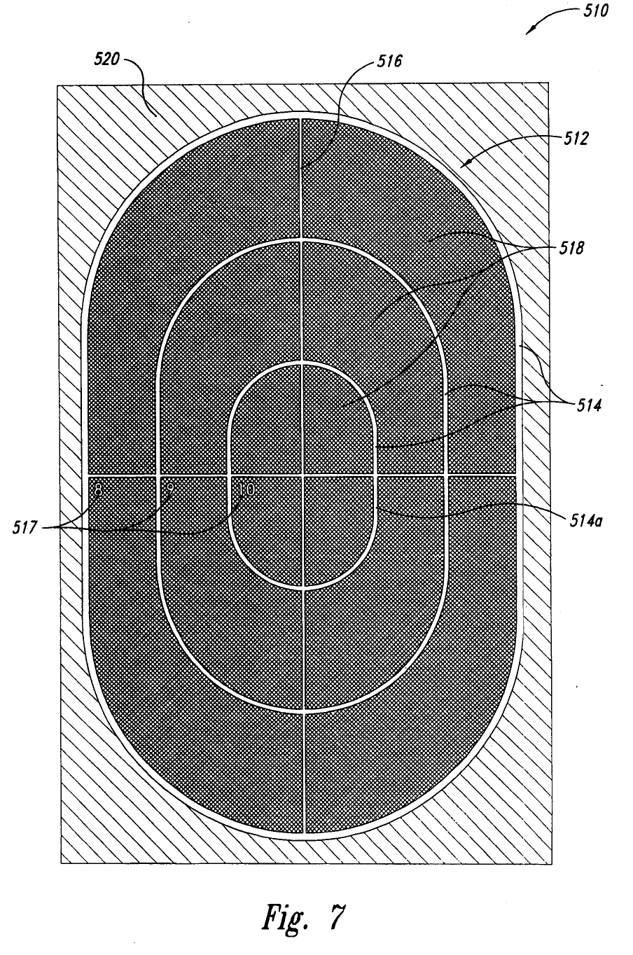

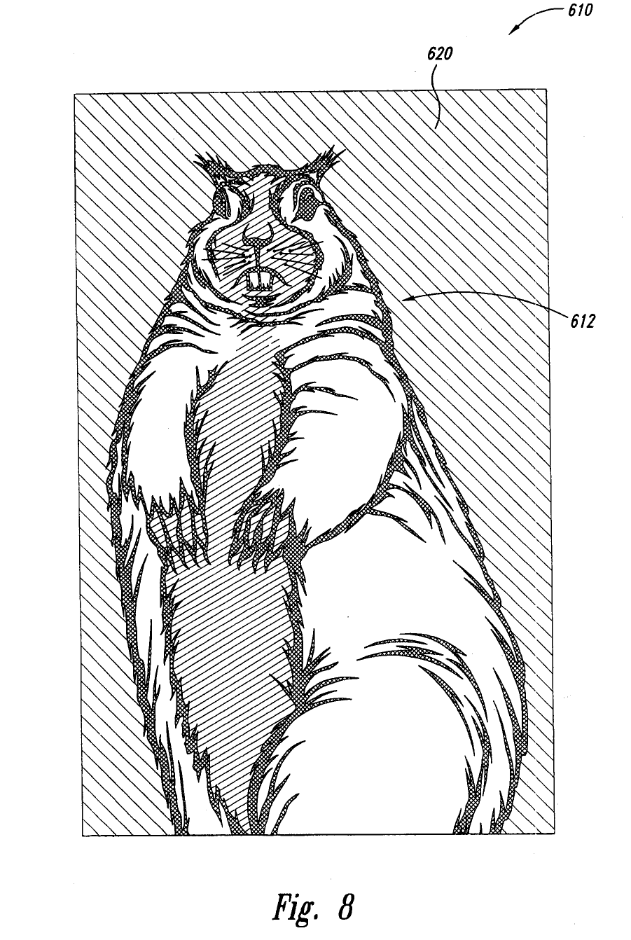

FIG. 2 is a schematic front view of the target 110 illustrated in FIG. 1. The target 110 includes a plurality of target images 112 and a field 120 between the target images 112. The individual target images 112 include a plurality of concentric rings 114 (identified individually as 114a-d), a cruciform 116 centered relative to the rings 114, and a plurality of arcuate segments 118 positioned between adjacent rings 114 and between an inner ring 114a and the cruciform 116. In the illustrated embodiment, the concentric rings 114 and the cruciform 116 have a first color, the arcuate segments 118 have a second color different than the first color, and the field 120 has a third color different than the first and second colors. For example, in several applications, the rings 114 and the cruciform 116 are fluorescent yellow, the arcuate segments 118 are black, and the field 120 is orange. In additional embodiments, however, the first, second, and/or third colors can include brown, red, white, green, and other suitable colors. In either case, the contrast between the different first, second, and third colors enables a shooter to easily identify the target image 112. In other embodiments, such as the embodiments described below with reference to FIGS. 7 and 8, the target 110 can include more or less than four target images 112, and some of the target images can have different configurations. For example, the target images may not include the concentric rings 114, the cruciform 116, and/or the arcuate segments 118.

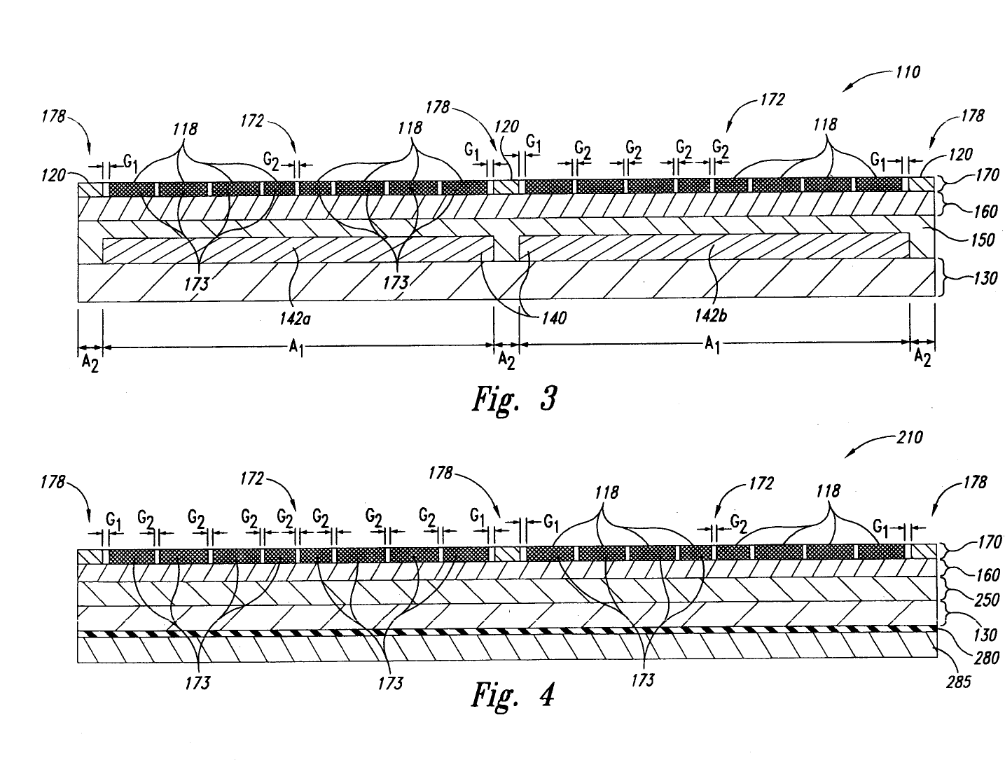

FIG. 3 is a schematic side cross-sectional view of the target 110 taken substantially along line 3-3 of FIG. 2. The illustrated target 110 includes a substrate 130, a first ink layer 140 formed on the substrate 130, a synthetic layer 150 deposited on the substrate 130 and the first ink layer 140, a release layer 160 formed on the synthetic layer 150, and a second ink layer 170 disposed on the release layer 160. The substrate 130 can be an organic material such as paper or an inorganic material such as mylar. The substrate 130 may also have a different color than the rings 114 (FIG. 2), the arcuate segments 118, and/or the field 120. For example, the substrate 130 may be white, green, red, brown, or another suitable color. The illustrated substrate 130 includes a plurality of first areas A₁ aligned with corresponding target images 112 (FIG. 2) and a second area A₂ aligned with the field 120.

The illustrated first ink layer 140 includes a plurality of sections 142 (only two shown and identified individually as 142a-b) covering corresponding first areas A₁ of the substrate 130. As a result, the first ink layer 140 does not cover the second area A₂ of the substrate 130. In other embodiments, however, the first ink layer 140 can cover the first and second areas A₁ and A₂ of the substrate 130. In either case, the color of the first ink layer 140 corresponds to the color of the rings 114 and the cruciform 116 because the rings 114 and the cruciform 116 are portions of the first ink layer 140 that are visible through the other layers.

The illustrated synthetic and release layers 150 and 160 extend across the target 110 over the first and second areas A₁ and A₂ of the substrate 130. The synthetic and release layers 150 and 160 can be generally transparent so that the first ink layer 140 and the second area A₂ of the substrate 130 are visible through the layers 150 and 160. The synthetic layer 150 can be made of an elastically deformable material that is configured to stretch when a projectile contacts the layer 150. For example, the synthetic layer 150 can be composed of polypropylene, synthetic varnish, or other suitable materials. In other embodiments, a natural material such as natural resin or varnish can also be used. The release layer 160 is configured to inhibit the second ink layer 170 from adhering to the target 110 such that a portion of the second ink layer 170 freely detaches from the target 110 when a projectile (e.g., bullet) strikes the target 110. The release layer 160 does not, however, cause the entire second ink layer 170 to detach when a projectile strikes the target 110. Rather, the release layer 160 allows the areas of second ink layer 170 outside of the strike zone to remain adhered to the target 110 such that only the portion of the second ink layer 170 proximate to the point of impact is removed from the target 110.

The synthetic and release layers 150 and 160 operate together to detach a portion of the second ink layer 170 surrounding the point at which a projectile strikes the target 110. For example, as the projectile passes through the target 110, the projectile stretches the synthetic layer 150, which fractures an adjacent region the second ink layer 170. The release layer 160 enables the fractured portion of the second ink layer 170 to detach from the target 110 and form an opening 171 (FIG. 2) in the second ink layer 170. As best seen in FIG. 2, the opening 171 is larger than a hole 132 formed by the projectile in the substrate 130 and/or the first ink layer 140. As a result, the opening 171 exposes a section of the substrate 130 or the first ink layer 140.

The illustrated second ink layer 170 includes (a) a plurality of first sections 172 aligned with corresponding first areas A₁ of the substrate 130, and (b) a second section 178 aligned with the second area A₂ of the substrate 130. The first and second sections 172 and 178 of the second ink layer 170 define the target images 112 and the field 120, respectfully. Specifically, the individual first sections 172 include a plurality of discrete arcuate portions 173 with external surfaces that form the arcuate segments 118 (best seen in FIG. 2) of the target image 112 (FIG. 2). The second section 178 surrounds the first sections 172 and has an external surface that forms the field 120 (best seen in FIG. 2). In the illustrated embodiment, the first sections 172 are spaced apart from the second section 178 by gaps G₁, which expose portions of the first ink layer 140. These exposed portions of the first ink layer 140 form the outer rings 114d (FIG. 2) of the target images 112. Adjacent arcuate portions 173 of the individual first sections 172 are spaced apart from each other by gaps G₂, which expose other portions of the first ink layer 140. These exposed portions of the first ink layer 140 form the inner concentric rings 114a-c and the cruciform 116 of the target images 112. In other embodiments, the first and second sections 172 and 178 of the second ink layer 170 may be spaced apart from the substrate 130 by different distances. For example, the first sections 172 can be disposed over the first and second area A₁ and A₂ of the substrate 130, and the second section 178 can be disposed on the portion of the first section 172 over the second area A₂ of the substrate 130.

One feature of the target 110 illustrated in FIGS. 2 and 3 is that the first sections 172 of the second ink layer 170, the second section 178 of the second ink layer 170, and the first ink layer 140 have different colors. An advantage of this feature is that the difference in color enables a shooter to clearly differentiate between the target image 112 and the field 120. The difference in color between the first ink layer 140 and the first sections 172 of the second ink layer 170 also provides a contrast so that the shooter can easily distinguish the different arcuate segments 118 of the target image 112. Another advantage of this feature is that the target 110 has a traditional bull's, eye configuration that is favored by some shooters.

Another feature of the illustrated target 110 illustrated in FIGS. 2 and 3 is that the synthetic and release layers 150 and 160 are positioned between the substrate 130 and the first and second sections 172 and 178 of the second ink layer 170. As a result, when a projectile strikes one of the target images 112, the portion of the corresponding first section 172 proximate to the impact point detaches and exposes the first ink layer 140. Moreover, when a projectile strikes the field 120, the portion of the second section 178 proximate to the impact point detaches and exposes the substrate 130. An advantage of this feature is that the target 110 enables a shooter to clearly identify his shot from a distance, even if the shot misses the target images 112 and strikes the field 120. As a result, the shooter does not need to walk to the target 110 and inspect the target 110 at close range after firing several rounds.

Another feature of the illustrated target 110 illustrated in FIGS. 2 and 3 is that the substrate 130 and the first ink layer 140 have different colors. Accordingly, if a shot strikes one of the target images 112, one color is exposed, and if a shot misses the target images 112 but strikes the field 120, a different color is exposed. An advantage of this feature is that the shooter can determine whether the shot struck one of the target images 112 based on the color exposed within the opening 171.

D. Additional Embodiments of Targets

FIG. 4 is a schematic side cross-sectional view of a target 210 in accordance with another embodiment of the invention. The target 210 is generally similar to the target 110 described above with reference to FIGS. 2 and 3. For example, the target 210 includes a substrate 130, a synthetic layer 250 on the substrate 130, a release layer 160 on the synthetic layer 250, and an ink layer 170 on the release layer 160. The illustrated target 210, however, does not include a second ink layer positioned between the substrate 130 and the release layer 160. As a result, portions of the substrate 130 are exposed through (a) the gaps G₁ between the first sections 172 and the second section 178 of the ink layer 170, and (b) the gaps G₂ between adjacent arcuate portions 173 of the individual first sections 172 of the ink layer 170. These exposed portions of the substrate 130 form the concentric rings and the cruciform of the target image. Moreover, other portions of the substrate 130 are exposed when portions of the first or second sections 172 or 178 of the ink layer 170 detach from the target 210. In other embodiments, the target 210 may include a second ink layer disposed between the substrate 130 and the release layer 160. In additional embodiments, the synthetic layer may not be transparent, but rather can be colored. In these embodiments, the colored synthetic layer is exposed through the gaps G₁ and G₂ and when portions of the ink layer 170 are removed.

The illustrated target 210 further includes an adhesive layer 280 formed on the substrate 130 opposite the synthetic layer 250, and a removable member 285 removably attached to the adhesive layer 280. The adhesive layer 280 is a pressure sensitive adhesive for selectively adhering the target 210 to the backing member 108 (FIG. 1) or other external surfaces. The removable member 285 can be selectively peeled or otherwise removed from the adhesive layer 280 before attaching the target 210. In additional embodiments, the target 210 may not include the adhesive layer 280 and the removable member 285.

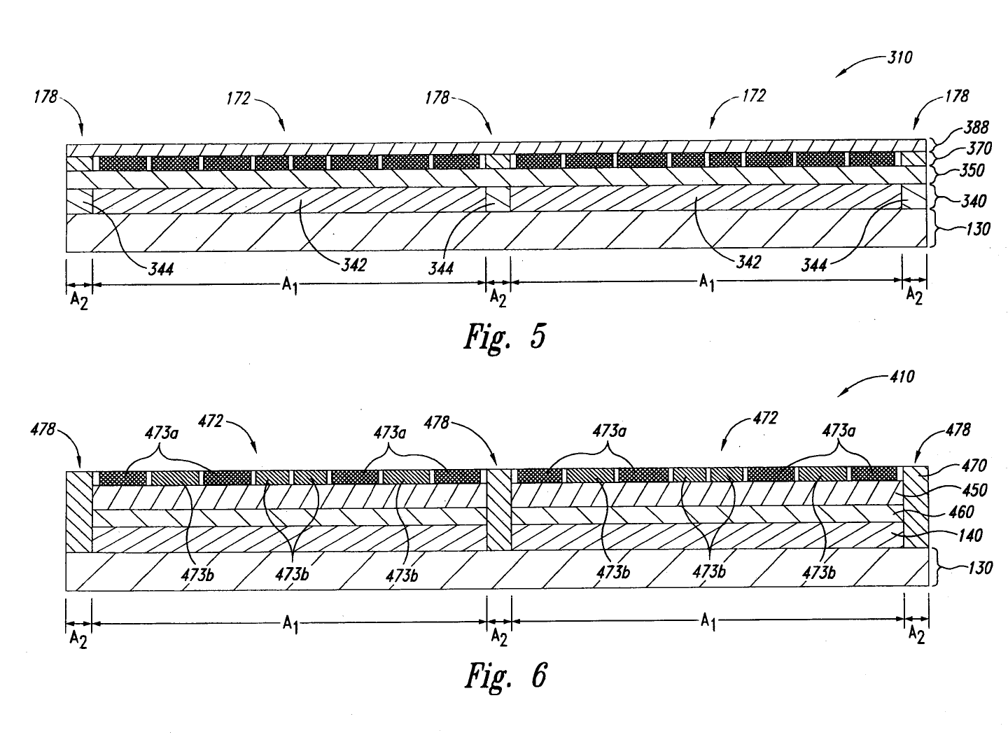

FIG. 5 is a schematic side cross-sectional view of a target 310 in accordance with another embodiment of the invention. The illustrated target 310 is generally similar to the target 110 described above with reference to FIGS. 2 and 3. For example, the target 310 includes a substrate 130, a first ink layer 340 on the substrate 130, a synthetic layer 350 on the first ink layer 340, and a second ink layer 370 on the synthetic layer 350. The illustrated target 310, however, does not include a release layer between the first and second ink layers 340 and 370. Rather, the illustrated second ink layer 370 includes a release agent that inhibits the layer 370 from adhering to the target 310 so that fractured portions of the layer 370 detach from the target 310. In other embodiments, the target 310 may include a release layer between the first and second ink layers 340 and 370, and/or the second ink layer 370 may not include a release agent.

In the illustrated embodiment, the first ink layer 340 includes a plurality of first sections 342 aligned with corresponding first areas A₁ of the substrate 130 and a second section 344 aligned with the second area A₂ of the substrate 130. The first sections 342 have a first color, and the second section 344 has a second color different than the first color. As a result, when a projectile strikes the target image, one of the first sections 342 with the first color is exposed, and when a projectile strikes the field, the second section 344 with the second color is exposed. The shooter can accordingly determine whether his shot struck a target image based on the exposed color. In other embodiments, the first and second sections 342 and 344 can have the same color.

The illustrated target 310 further includes a protective layer 388 disposed over the second ink layer 370. The protective layer 388 protects the second ink layer 370 from scratching or other damage and inhibits accidental removal of the layer 370. In other embodiments, the target 310 may not include the protective layer 388.

FIG. 6 is a schematic side cross-sectional view of a target 410 in accordance with another embodiment of the invention. The target 410 is generally similar to the target 110 described above with reference to FIGS. 2 and 3. For example, the target 410 includes a substrate 130, a first ink layer 140, a synthetic layer 450, a release layer 460, and a second ink layer 470. In the illustrated target 410, however, the release layer 460 is positioned between the first ink layer 140 and the synthetic layer 450, and the synthetic and release layers 450 and 460 are disposed on only portions of the target 410. Specifically, the synthetic and release layers 450 and 460 are aligned with the first areas A₁ of the substrate 130 and do not cover the second area A₂ of the substrate 130.

The illustrated second ink layer 470 includes a plurality of first sections 472 aligned with corresponding first areas A₁ of the substrate 130 and a second section 478 aligned with the second area A₂ of the substrate 130. The individual first sections 472 include a plurality of first arcuate portions 473a and a plurality of second arcuate portions 473b arranged concentrically with the individual second arcuate portions 473b positioned between adjacent pairs of first arcuate portions 473a. The illustrated first and second arcuate portions 473a-b have different colors and form the arcuate segments of the target image. The second section 478 can have the same color as either the first or the second arcuate portions 473a-b. Alternatively, the second section 478 can have a different color than the first and second arcuate portions 473a-b. In either case, because the synthetic and release layers 450 and 460 are not positioned between the second section 478 and the substrate 130, the area around the point of impact is not expected to fracture and detach from the target 410 when a projectile strikes the second section 478 of the second ink layer 470.

E. Additional Embodiments of Target Images

FIG. 7 is a schematic front view of a target 510 in accordance with another embodiment of the invention. The target 510 is generally similar to the target 110 described above with reference to FIGS. 2 and 3. For example, the target 510 includes a target image 512 and a field 520 surrounding the target image 512. The illustrated target 510, however, includes a single target image 512 having a generally oval shape. The target image 512 includes a plurality of concentric rings 514, a cruciform 516 centered relative to the rings 514, a plurality of numbers 517 marking corresponding rings 514, and a plurality of arcuate segments 518 between adjacent rings 514 and between an inner ring 514a and the cruciform 516. In the illustrated embodiment, the concentric rings 514 and the cruciform 516 have a first color, the arcuate segments 518 have a second color different than the first color, and the field 520 has a third color different than the first and second colors. In other embodiments, the entire target image 512 can have a single color. In either case, the arcuate segments 518 and the field 520 are formed with an ink layer that is configured to partially detach when a projectile contacts the target 510. In additional embodiments, the target 510 can have more than one target image, and/or the target image can have a different configuration.

FIG. 8 is a schematic front view of a target 610 in accordance with another embodiment of the invention. The target 610 is generally similar to the target 510 described above with reference to FIG. 7. For example, the target 610 includes a target image 612 and a field 620 surrounding a portion of the target image 612. The illustrated target image 612, however, does not include a bull's eye, but rather has a vermin. In the illustrated embodiment, the target image 612 has a first color defining the outline and contour of the vermin's body, a second color shading one portion of the vermin's body, and a third color shading another portion of the vermin's body. The illustrated field 620 has a fourth color different than the first, second, and third colors. In several applications, only the target image 612 is formed with an ink layer configured to partially detach when a projectile contacts the target 610. In other applications, the target image 612 and the field 620 are both formed with an ink layer configured to partially detach when a projectile contacts the target 610. In either case, the target image 612 may include a different animal or object in other embodiments.

From the foregoing, it will be appreciated that specific embodiments of the invention have been described herein for purposes of illustration, but that various modifications may be made without deviating from the spirit and scope of the invention. For example, many of the elements of one embodiment can be combined with other embodiments in addition to or in lieu of the elements of the other embodiments. Accordingly, the invention is not limited except as by the appended claims.

I/We claim:

1. A firearm target, comprising:
a substrate;
a release layer on the substrate; and
an ink layer on the release layer such that the release layer is positioned between the ink layer and the substrate, the ink layer at least partially defining a target image and having a first section with a first color and a second section with a second color different than the first color.

2. The target of claim 1 wherein:
the substrate comprises a first area, a second area different than the first area, and a third color different than the first and second colors;
the ink layer comprises a first ink layer;
the target further comprises a second ink layer positioned between the substrate and the release layer;
the second ink layer covers the first area of the target and has a fourth color different than the first, second, and third colors;
the first section of the first ink layer covers at least a portion of the second ink layer and includes a plurality of discrete portions separated by gaps;
the gaps between adjacent portions of the first section of the first ink layer expose sections of the second ink layer; and
the second section of the first ink layer covers the second area of the substrate.

3. The target of claim 1 wherein:
the ink layer comprises a first ink layer;
the target further comprises a second ink layer positioned between the substrate and the release layer;
the second ink layer covers at least a portion of the substrate; and
the first section of the first ink layer covers at least a portion of the second ink layer.

4. The target of claim 1 wherein:
the ink layer comprises a first ink layer;
the target further comprises a second ink layer positioned between the substrate and the release layer; and
the second ink layer has a third color different than the first and second colors.

5. The target of claim 1 wherein:
the substrate has a third color different than the first and second colors;
the ink layer comprises a first ink layer;
the target further comprises a second ink layer positioned between the substrate and the release layer; and
the second ink layer has a fourth color different than the first, second, and third colors.

6. The target of claim 1 wherein the release layer and the ink layer are configured so that penetration of a projectile removes a portion of the ink layer and exposes a surface adjacent to the ink layer.

7. The target of claim 1 wherein the second section of the ink layer is disposed outboard the target image.

8. The target of claim 1 wherein the first section of the ink layer at least partially defines the target image and the second section of the ink is disposed outboard the target image.

9. The target of claim 1 wherein the first section of the ink layer comprises a plurality of spaced apart portions separated by gaps.

10. The target of claim 1 wherein the first section of the ink layer comprises a plurality of discrete arcuate portions arranged concentrically.

11. The target of claim 1 wherein the substrate comprises a first surface carrying the release layer and a second surface opposite the first surface, and wherein the target further comprises:
an adhesive layer on the second surface of the substrate; and
a removable member detachably coupled to the adhesive layer.

12. The target of claim 1 wherein the substrate comprises an inorganic material.

13. The target of claim 1 wherein the substrate comprises mylar.

14. The target of claim 1 wherein the substrate comprises an organic material.

15. The target of claim 1 wherein:
the target image is a first target image;
the target further comprises a second target image spaced apart from the first target image; and
the second section of the ink layer is disposed between the first and second target images.

16. The target of claim 1, further comprising a synthetic layer between the ink layer and the substrate.

17. The target of claim 1 wherein the ink layer comprises a first ink layer, and wherein the target further comprises a second ink layer between the release layer and the substrate, the second ink layer comprising (a) a first section having a third color different than the first and second colors, and (b) a second section having a fourth color different than the first, second, and third colors.

18. A firearm target, comprising:
a substrate;
a first ink layer covering at least part of the substrate; and
a second ink layer carried by the substrate, the second ink layer including (a) a first section having a first color and covering at least part of the first ink layer, and (b) a second section having a second color different than the first color, wherein the second ink layer is configured so that the impact of a firearm projectile detaches a portion of the second ink layer from the substrate and exposes a surface of the first ink layer and/or the substrate.

19. The target of claim 18 wherein the second ink layer comprises a release agent.

20. The target of claim 18, further comprising a release layer between the first ink layer and the second ink layer.

21. The target of claim 18 wherein the first ink layer comprises a first section having a third color and a second section having a fourth color different than the third color.

22. The target of claim 18 wherein:
the first section of the second ink layer comprises a plurality of spaced apart portions separated by gaps; and
the first ink layer is visible through the gaps.

23. A target, comprising:
a substrate; and
an ink layer carried by the substrate, the ink layer including a first section having a first color, and a second section having a second color different than the first color, wherein the ink layer is configured such that penetration of a projectile removes a portion of the ink layer and exposes a surface adjacent to the ink layer.

24. The target of claim 23, further comprising a release layer between the substrate and the ink layer.

25. The target of claim 23 wherein the ink layer comprises a first ink layer, and wherein the target further comprises a second ink layer between the first ink layer and the substrate.

26. A firearm target, comprising:
a substrate;
an ink layer carried by the substrate, the ink layer including a first section with a first color and a second section with a second color different than the second color; and
means for detaching a portion of the ink layer from the substrate and exposing at least a portion of a surface adjacent to the ink layer when a projectile strikes the target.

27. The target of claim 26 wherein the means for detaching comprise a release agent in the ink layer.

28. The target of claim 26 wherein the means for detaching comprise a release layer positioned between the ink layer and the substrate.

29. The target of claim 26 wherein the ink layer comprises a first ink layer, and wherein the target further comprises a second ink layer positioned between the first ink layer and the substrate.

30. A method for manufacturing a firearm target, the method comprising:
forming a release layer on a substrate; and
printing an ink layer on the release layer with the ink layer at least partially defining a target image and having a first section with a first color and a second section with a second color different than the first color.

31. The method of claim 30 wherein the ink layer comprises a first ink layer, and wherein the method further comprises depositing a second ink layer between the release layer and the substrate.

32. The method of claim 30 wherein:
the ink layer comprises a first ink layer;
the method further comprises depositing a second ink layer between the release layer and the substrate;
the second ink layer has a third color different than the first and second colors; and
printing the first ink layer comprises printing the first ink layer so that the first section covers at least a portion of the second ink layer.

33. The method of claim 30 wherein forming the release layer comprises depositing a release material that inhibits the ink layer from adhering to the target so that penetration of a projectile removes a portion of the ink layer and exposes a surface adjacent to the ink layer.

34. The method of claim 30 wherein printing the ink layer comprises depositing the ink layer so that the first section includes a plurality of spaced apart portions.

35. The method of claim 30 wherein printing the ink layer comprises depositing the ink layer with a plurality of arcuate portions arranged concentrically.

36. The method of claim 30, further comprising disposing an adhesive layer on the substrate opposite the release layer.

37. The method of claim 30 wherein printing the ink layer comprises depositing the ink layer so that the first section at least partially defines the target image and the second section is disposed outboard the target image.

38. A method for manufacturing a firearm target, the method comprising:
forming a first ink layer on a first area of a substrate;
placing a release layer on the first ink layer and a second area of the substrate, the second area being different than the first area;
disposing a first section of a second ink layer on the release layer so that the first section covers at least a portion of the first ink layer and at least partially defines a target image, the first section having a first color; and
printing a second section of the second ink layer on the release layer so that the second section covers the second area of the substrate and has a second color different than the first color.

39. The method of claim 38 wherein forming the first ink layer comprises printing a first ink layer having a first section with a third color and a second section with a fourth color, and wherein the first, second, third, and fourth colors are different.

40. The method of claim 38 wherein disposing the first section of the second ink layer comprises printing the first section of the second ink layer so that sections of the first ink layer are visible.

41. The method of claim 38 wherein placing the release layer comprises depositing a release material that inhibits the second ink layer from adhering to the target so that penetration of a projectile removes a portion of the second ink layer and exposes at least one of the first ink layer or the substrate.
